(19) United States
(12) Patent Application Publication
(10) Pub. No.: US 2025/0049630 A1
(43) Pub. Date: Feb. 13, 2025

(54) Haptic Therapy to Reduce Negative Effects of Neurological Disorders

(71) Applicant: James F. Kramer, Foster City, CA (US)

(72) Inventor: James F. Kramer, Foster City, CA (US)

(21) Appl. No.: 18/798,809

(22) Filed: Aug. 8, 2024

Related U.S. Application Data
(60) Provisional application No. 63/531,456, filed on Aug. 8, 2023.

(51) Int. Cl. A61H 23/02

(52) U.S. Cl. CPC A61H 23/0263; A61H 2023/0281; A61H 2201/0153; A61H 2201/0157; A61H 2201/1215; A61H 2201/1638; A61H 2201/1642; A61H 2201/165; A61H 2201/1671; A61H 2201/5015; A61H 2201/5084; A61H 2201/5097; A61H 2205/067; A61H 2205/12; A61H 2230/105

(57) ABSTRACT

Systems and methods of neurofeedback intervention reduce the negative effects of neurological disorders, including Parkinson's disease, essential tremor, dystonia, epilepsy, dysfunction following stroke, obsessive-compulsive disorder, Tourette syndrome, dementia, complex regional pain syndrome, and the like. Haptic devices, including eccentric-mass actuators and computer-controlled tightening haptic straps provide haptic sensation to a body. The haptic sensations are controlled by a haptic control signal determined by a control program. The control program may determine the haptic control signal from a neurological signal from an EEG, an electrode detecting a signal in a nerve fiber, or an accelerometer. Haptic therapy un-trains and desynchronizes abnormal neuron synchrony, to reduce the negative effects of neurological disorders.

### FIELD OF THE INVENTION

The field of this invention is sensing of neurological conditions and haptic therapy to reduce neurological disorders.

### BACKGROUND OF THE INVENTION

Neurological disorders can be debilitating. Neurological disorders showing improvement when the patient exposed to coordinated reset stimulation (CRS) include Parkinson's disease, essential tremor, dystonia, epilepsy, dysfunction following stroke, obsessive-compulsive disorder, Tourette syndrome, dementia, complex regional pain syndrome, and the like.

An opportunity exists to provide haptic therapy to reduce the negative effects of neurological disorders.

### SUMMARY OF THE INVENTION

Systems and methods for haptic therapy to reduce the negative effects of neurological disorders in accordance with embodiments of the invention are illustrated.

The present invention includes systems and methods of neurofeedback intervention to reduce the negative effects of neurological disorders, including Parkinson's disease, essential tremor, dystonia, epilepsy, dysfunction following stroke, obsessive-compulsive disorder, Tourette syndrome, dementia, complex regional pain syndrome, and the like.

Haptic actuators, including but not limited to tactile stimulators, tactile actuators, and the like, are referred to here as TAs. TAs, including but not limited to eccentric rotating-mass actuators (ERMs) and linear resonant actuators (LRAs), may be placed on one or more of a user's body parts, including but not limited to the user's palm, forearm, biceps, hamstring, quadriceps, calf, foot arch, under arch of toe(s), tip of toe(s), between toe(s)-particularly between big toe and second toe in the gap between them.

Electrical-activation electrodes (EAEs) are held in a desired location against the surface of a user's skin. EAEs may include electrodes commonly associated with electroencephalograms (EEGs), electrocorticograms (ECoGs), and magnetoencephalograms (MEGs). Some beneficial locations for EAEs are the user's head, forearm, biceps, hamstring, quadriceps, calf, foot arch, under arch of toe(s), tip of toe(s), between toe(s)-particularly between big toe and second toe in the gap between them.

EAEs may be positioned in a band holding one or more TAs, where the TA is actuated in response to the electrode(s) sensing abnormal activation. Abnormal activation includes, but is not limited to, a cycling on/off of an electrode, paired 180-degree-out-of-phase electrodes, indicating shaking of a structure, typically an extremity of a user's body part.

A band, which may include elastic, is typically worn around a user's forearm, biceps, hamstring, quad, or calf muscle, or around a portion of a user's hand, finger, foot, or toe, and having EAEs for sensing electrical activation in a motor nerve to a user's muscle. The band typically further includes a TA, which may include a static TA (STA) or a dynamic TA (DTA). A DTA may include a vibrotactile actuator (VTA), such as an eccentric rotating-mass actuator (ERM), a linear resonant actuator (LRA), and the like. The TA may be an electrical TA (ETA), including electrocutaneous stimulation (ECS). The ECS may include an electrode on the surface of the skin, or may include an electrode inserted into the skin.

Bands of TAs may include a plurality of TAs encircling a limb. In a useful embodiment, TAs are placed over a tendon, ligament, motor neuron fiber, or sensing neuron fiber.

In a useful embodiment, one or a plurality of EAEs, and one or a plurality of MTAs, are functionally connected to an interface unit (IU). The IU receives and conditions signals from the EAEs, and amplifies and sends signals to the VTAs. A computing device (CD), which may be a smart phone, tablet, or other computing device, receives EAE signals from the IU, processes them, and sends a signal to the IU for the VTAs. The CD may be connected wirelessly or by wire to the IU. Wireless signals may come from any convenient CD, including but not limited to an Edge or Cloud computer, and may initiate from a healthcare provider, which may be human or computer generated, and which may be Al generated.

The CD typically receives signals from the IU initiating from the EAEs, monitors the electrical signals over time, which may include SMRs, which may include SMR spindles, and which detects abnormal signals. When abnormal signals are detected, the CD determines a corrective signal (CS) and sends it to the IU to present to one or more VTAs. The CS may be a complex signal that is a spatiotemporal (ST) time-dependent waveform (TDW), where a different TDW may be sent to multiple different VTAs, and with different phase shifts, to provide a coordinated CS. Application of the CS to the VTAs may result in Coordinated Reset (CR), which retrains abnormally-activating neurons in the brain not to activate to unlearn pathological synaptic connectivity, and to desynchronize and weakly couple states; thus, reducing the negative effects of certain neurological disorders.

EAEs may be placed in a head covering, such as a cap or hat. EAEs on a user's head typically sense sensorimotor rhythm (SMR), where the SMR activity is recorded by a brain-activity recorder and used to identify SMR spindles.

There are four cutaneous mechanoreceptors: Meissner corpuscles, Pacinian corpuscles, Merkel discs, and Ruffini corpuscles. Meissner Corpuscles (MCs) are highly prevalent in fingertips, hands, feet, toes, lips, and external genitalia. MCs are effective at detecting dynamic tactile sensations between 10-50 Hz. When a TA is used to provide feedback for CR, it is not always convenient to position TAs on a user's fingertips, which prevents the user's hands from being used for other activity, such as typing. Accordingly, even though the density of MCs is lower in the forearm, a plurality of VTAs may be conveniently used around the user's forearm to provide vibrotactile stimulation to the user's muscles that actuate the fingertips, providing useful actuation to achieve CR.

A narrow or small-diameter protrusion, referred to here as a “tactor,” may be functionally associated with a TA. Tactors are typically for focusing tactile stimulation on a relatively small region of a body part or portion of skin. For example, one or a plurality of tactors may focus a haptic stimulation on a user's fingertip so only a small region of MCs are stimulated.

TAs may be mounted on the user's forearm, wrist, or finger, and tendons in sheaths (such as a Bowden cable) may be used to transmit tactile movement to the fingertips. One TA example includes a “lifter” structure where an eccentric mass or rotating cam of a VTA presses against the lifter. The lifter may use a coil spring or a flex spring, such as a live hinge, to return the lifter to its starting position. The Bowden cable at the fingertip may attach the tendon to a flexing hinge, which may include a protrusion (tactor) for focusing tactile stimulation on the non-hinged end, to apply tactile stimulation to the user's finger, such as the fingertip or finger nail.

TAs may be positioned over a user's finger phalanx, such as the medial phalanx. The TA may be positioned on the dorsal side of the phalanx.

A VTA positioned over the medial phalanx may apply a rotating cam directly to a flexible hinge, causing it to flex with each rotating cycle of the cam, and where the free end of the flexible hinge includes a tactor protrusion to focus pressure and tactile stimulation on small region of skin.

Such a VTA may include multiple cams on a single motor shaft, where the maximum radius of each cam is offset by an angle about the shaft, whereby as the shaft rotates, different flexible hinges can be engaged, whereby different tactors can be applied to the skin at different positions at different times with each rotary cycle of the motor. The same cam may also be used to apply a force to different flexible hinges. For example, a force may be applied down to a first hinge when the cam is closest to the surface of the skin, and a force may be applied to lift a second hinge when the cam is furthest above the surface of the skin, e.g., when the cam rotates 180 degrees between the first hinge and second hinge.

TAs may be positioned against the palm, and may use a glove to hold the TAs in place.

VTAs may be geared to lower the rotational speed, and to provide more torque.

Alternatively to using EAEs, accelerometers may be placed on a body part to detect tremor. When tremor is detected, a TA may be activated to counteract abnormal neuronal synchrony by desynchronization. A forearm sleeve, a calf-high sock, a glove, a shoe, and the like may be used to position the EAEs, accelerometers, TAs, and the like, in functional relations to a body part.

The goal of CR is as a therapy to help unlearn abnormal synaptic connectivity and reduce pathological synchronization, which is a result of Parkinson's disease.

CR employs phase resetting stimuli to counteract the exaggerated phase-amplitude coupling (PAC) of beta phase to broadband gamma amplitude in the EEG over sensorimotor cortex.

Positioning a VTA on the dorsal side of a user's medial phalanx, instead of the pad of the user's fingertips, may reduce the number of mechanoreceptive units stimulated, and also stimulate a smaller cortical and/or brain volume (such as the Thalamic neurons), but positioning the VTA on the dorsal side of the user's medial phalanx has an ergonomic benefit to the user of allowing them to use their fingers unencumbered during therapy.

An inventive foot holder, foot support, shoe, insole, or sock with stimulation to the feet and toes is an alternative to stimulating a user's fingers and hand, which maintains stimulation to a large number of mechanoreceptors and cortical volume, while still providing the ergonomic advantages of allowing the user to use their hands unencumbered. This system may reduce freezing of gait (FOG).

Activating the TAs at random times, although possibly not as effective as activating the TAs in response to detected SMR spindles, may provide some CR benefit, while greatly reducing the inconvenience to the user of needing to wear EAEs.

PD patients showed significant improvement in motor tasks when vibratory stimulation was delivered to muscles of the extremities.

In a useful embodiment, an accelerometer, an EAE, or a bend sensor, on a user's hand, arm, or a phalanx, senses “essential tremor” in a PD patient. When sensed, a VTA on the same or a different phalanx, including a phalanx on a different hand, or a portion of a foot, such as a toe or metatarsal, or on the forearm, or biceps, or sternum, is activated until the tremor subsides, for a pre-set time, or for a preset time.

The subject invention incorporates the following observations:
1. Ruffini's corpuscles are the feedback sensor for limb position. When the corpuscle or corresponding nerve fiber becomes defective, stretch signals are delayed or aberrant, causing the feedback loop to become unstable.
2. Vibrotactile coordinated reset stimulation (VCRS) reduces the synaptic weighting, to lower the feedback loop gain, to increase stability of muscles movement and reduce tremors.
3. Upregulating SMR spindles effectively increases the brains “sampling rate,” which increase stability of a body's muscle control system by increasing the Nyquist frequency.
4. Meissner and Pacinian corpuscles act like “differentiators,” since they respond quickly and then fade, and Merkel and Ruffini's corpuscles act like “integrators,” since their response is slower but persistent over time.

### BRIEF DESCRIPTION OF THE DRAWINGS

FIG. 1A is a side section view, and FIG. 1B is an end section view, of an eccentric rotating-mass actuator (ERM). FIG. 1C is a perspective view of an ERM. FIG. 1D is a perspective view of a covering for the ERM of FIG. 1C, with randomly placed tactors for indenting a user's skin, to create an inhomogeneous indentation profile on a body part. FIG. 1E is a side view of an ERM with foam associated with tactors to prevent the tactors from touching a body part when the ERM is not activated.

FIGS. 2A-2B are side views, and FIGS. 2C-2D are end views, of an ERM causing a flexible member to contact a body part as a rotating member of the ERM rotates.

FIG. 3A is a perspective view, and FIG. 3B is an end view, of a haptic strap for covering a portion of a body part, such as a forearm or calf, where the haptic strap includes apparatus for computer-controlled tightening of the strap around the body part. The haptic strap may also include one or a plurality of TAs, including but not limited to ERMs and LRAs.

FIG. 4 is a frontal stick-figure view of exemplary placement of haptic bands on portions of a human body, including a forearm, biceps, hamstring, quad, and/or a calf muscle. A haptic band may also be placed around a portion of a hand, finger, foot, or toe, head, and/or any other desired body part.

FIG. 5 is an end view of an ERM and haptic band around a body part, such as a finger. When the eccentric rotating member of the ERM rotates to a top position, it may pull the band tighter, causing the tactor to indent the body part. Foam, or any other convenient return structure, may be used to retract the tactor from the body part when the eccentric rotating member rotates away from the top position, releasing tension in the band.

FIG. 6 is a side view of a haptic arm sleeve, a plurality of ERMs, a plurality of accelerometers, a controller, and a battery. The sleeve may optionally include a computer-controlled tightening strap. The sleeve may also include electrodes to detect muscle activation signals.

FIG. 7 is a side view of a haptic leg sock, a plurality of ERMs, a plurality of accelerometers, a controller, and a battery. The sock may optionally include a computer-controlled tightening strap. The sock may also include electrodes to detect muscle activation signals.

FIG. 8 is a side cross section view of a haptic shoe having tactile stimulators for applying a tactile sensation to toes, and optionally to other areas of a foot. The shoe may also include one or a plurality of accelerometers.

FIG. 9 is an end cross section view of two toes inside a haptic shoe, sock, or an insole. (Other toes are not shown.) An ERM has a rotating member that causes a flexible member, optionally with a tactor, to flex, causing the tactor to contact a body part. The ERM may be located below toes, between toes, above toes, or to the side of toes. The ERM may be located in the sole portion of a haptic shoe. The ERM may be located in the sole portion of a haptic shoe and beneath, to the side, or above, any portion of a foot.

FIGS. 10A-10E are end views of rotating actuators, where such actuators may be used to cause a flexible member to flex, including, but not limited to the flexible member of FIG. 9.

FIG. 11 is an end view of an ERM with lifter-pin tactors. As the rotating member of the ERM rotates, it forces the lifter-pin tactors to move and contact a body part, such as a finger, toe, arm, leg, abdomen, and the like.

FIG. 12A is a schematic feedback control block diagram for how a brain may control an arm muscle, where Ruffini's corpuscles provide a feedback sensor. FIG. 12B is a schematic feedback control block diagram for a computer-controlled system to sense a first body part, such as of a biological control system, and control one or a plurality of TAs to stimulate a body part, which may be the first body part, or a second body part, to help retrain and desynchronize abnormal neuron synchrony.

FIG. 13A is a block diagram of a controller, sensor, haptic actuator, and power source. FIG. 13B is neuro-feedback system for a body.

FIG. 14A is a side view of a fingerless partial glove with a tactile stimulator on a fingertip. FIG. 14B is an end view of a tactile stimulator without foam. FIG. 14C is an end view of a tactile stimulator with foam.

FIG. 15A is a side view of a fingerless partial glove with a TA with a spring-loaded clip on a fingertip. FIG. 15B is a side view of the partial glove of FIG. 15A replaced by one or more elastic straps, where the straps may be adjustable. FIG. 15C is an end view of a tactile stimulator held against the pad of a fingertip by a clip and foam padding.

FIG. 16 is a side view of a glove with TA positioned against the pad of a fingertip.

FIGS. 17A and 17B are side-perspective views of a hand with electronics strapped to the back, and with a tactile stimulator attached by fingertip attachment structure that positions it in functional relationship to a fingertip. In this embodiment, the tactile stimulator is electrically connected to the electronics using a flexible circuit board, such as shown in the perspective view of FIG. 17C.

FIG. 18A is a perspective view of a haptic foot support, such as a haptic sandal comprising a plurality of tactile stimulators for toes and a foot. FIG. 18B is a top view of FIG. 18A. FIG. 18C is a side partial-transparent view of FIG. 18A. FIG. 18D is a close up side partial-transparent view of the toe area of FIG. 18A. FIG. 18E is a side view of a tactile stimulator which may find use in the embodiment of FIG. 18A.

FIGS. 19A and 19C are end views of an ERM in a casing having a protrusion (tactor) for focused stimulation of a body part. FIGS. 19B and 19D are perspective views of the apparatus of FIG. 19A.

FIG. 20A is a perspective view of a TA, such as a linear resonant actuator (LRA) that moves a protrusion (tactor) from side to side. FIG. 20B is a perspective view of a TA, such as an ERM, that moves a tactor up and down.

FIG. 21A is an end view of toes of a foot, where an ERM moves a lever to cause a tactor to stimulate a body part, such as a toe. FIG. 21B is an end view of a useful embodiment of an ERM for stimulating a body part, such as a toe. FIG. 21C is an end view of another useful embodiment of an ERM moving a structure to stimulate more than one toe or body part simultaneously.

FIG. 22 is a top view of one or a plurality of TAs included in a foot holder, foot support, shoe, sandal, and/or an insole, and the like.

FIG. 23A is a side cross-section view of a TA, such as may be included in a foot holder, foot support, shoe, sandal, or insole, where the TA may include a disc stimulator and may be suspended in foam, typically soft-density foam or medium-density foam. FIG. 23B is another side cross-section view of a TA, such as a disc stimulator, and having a protrusion, which may be suspended in foam, and may also include foam over the top portion of the stimulator. FIG. 23C is another side cross-section view of a TA, such as an ERM, having a protrusion, and suspended in foam, and may also include foam over the top portion of the stimulator.

FIG. 24A is a top view of a foot holder, foot support, shoe, sandal, or insole including a TA, a controller with wireless communication, drive circuitry such as PWM, and a power source such as a battery. FIG. 24B is a block diagram of a circuit for receiving a wireless signal from a wireless transmitter, receiving electrical power, creating a stimulation signal and sending the signal to a TA. This foot holder, foot support, shoe, sandal, or sole may be used to reduce the symptoms of freezing of gait (FOG), as well as other neuro pathologies.

FIG. 25A is a top view of a foot holder, foot support, shoe, sandal, or insole including a plurality of ERMs for providing haptic therapy. FIG. 25B is a perspective view of an ERM. FIG. 25C is an end view of an ERM suspended in foam. FIG. 25D is an end view of an ERM suspended in foam and covered by a flexible covering, typically a thin elastic covering.

FIG. 26A is a perspective view of an ERM having one or a plurality of protrusions (tactors) for focusing tactile stimulation. FIG. 26B is an end view of an ERM having at least one tactor for focusing tactile stimulation on a body part.

FIG. 27A is a block diagram of a pulse-width modulation (PWM) configuration for efficiently activating a plurality of vibrotactile motors with the PWM signal. FIG. 27B is a block diagram of a pulse-width modulation (PWM) configuration for activating a plurality of vibrotactile motors with a plurality of PWM signals.

FIG. 28 is a side view of a haptic a foot holder or foot support, such as a shoe/sandal/insole, including one or a plurality of ERMs for providing haptic therapy, and positioned in wireless communication with a wireless charging foot rest or pad.

FIG. 29 is a side section view of a haptic foot holder or foot support, such as a shoe/sandal/insole, including one or a plurality of ERMs for providing haptic therapy, where the haptic foot holder or foot support may include foam or other compliant material as suspension below and/or above the VTA, so when a body part, such as a toe, presses down, the VTA can still vibrate without stalling or having its motion being significantly resisted or damped.

FIG. 30 is a side view of a haptic-therapy system, including a wrist-mounted assembly and a foot-mounted assembly communicating wirelessly two-ways.

### DETAILED DESCRIPTION OF THE INVENTION

A system is provided for haptic therapy to reduce the negative effects of neurological disorders.

The subject invention is further described in detail hereunder referring to the embodiments provided in the drawings. Various TAs may be used, such as ERMs, including a vibrotactile disc, such as provided by DIANN, which is a mini vibration motor, DC 3V, 12000 RPM, 10 mm x2.7 mm. A convenient cylindrical TA is an ERM, such as is provided by Tatoko, which is a DC coreless 1.5-3V 8000-16000 RPM motor for electric toothbrushes, 7×25 mm.

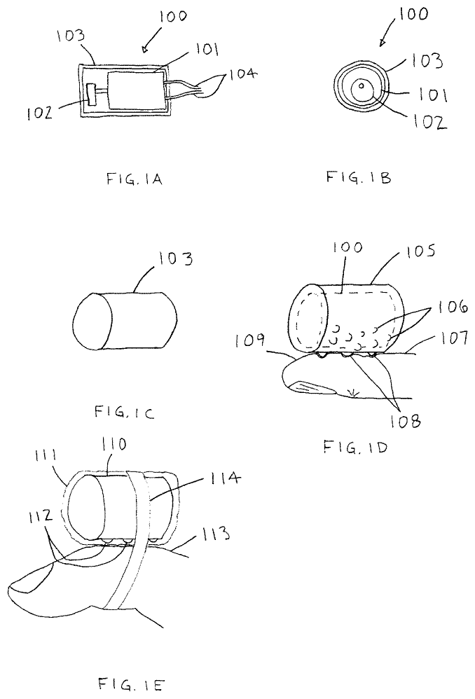

FIG. 1A is a side section view, and FIG. 1B is an end section view, of an eccentric rotating-mass actuator (ERM) 100. The ERM includes a motor 101, an eccentric mass 102, a housing 103, and electrical wire connections 104. FIG. 1C is a perspective view of an ERM housing 103. FIG. 1D is a perspective view of a covering for the ERM of FIG. 1C, with randomly placed tactors for indenting a user's skin, to create a non-homogeneous indentation profile on a body part, such as a finger 109. A tactor is typically a tactile concentrator and may be used for indenting and focusing a tactile sensation on a desired mechanoreceptor receptive field. FIG. 1E is a perspective view of an ERM with foam associated with tactors to prevent the tactors from touching a body part, such as a finger 113, when the ERM is not activated. The foam of FIG. 1E may include a soft or light foam “jacket” covering one or more tactors, so the user only perceives tactile sensation from the tactors when the ERM is vibrating. When the ERM is vibrating, the foam between a tactor and a body part is compressed, allowing pressure from the tactor to be perceived by the body part. The ERM may be secured to the body part by a strap 114.

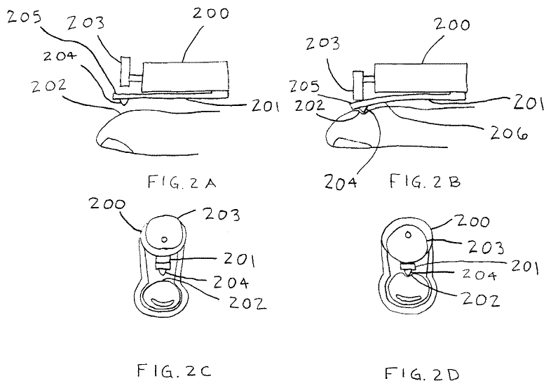

FIGS. 2A-2B are side views, and FIGS. 2C-2D are end views, of an ERM causing a flexible member to contact a body part, such as a finger pad 202, as a rotating member of the ERM rotates. The apparatus of FIGS. 2A-2D may include a tactor to apply a focused tactile sensation on a specific region of a body part. In the figures, a tactor is positioned near the end of the flexible member. In the figures, the flexible member is a cantilever flexible member; however, any convenient flexible member may be used. When a rotating mass of an ERM rotates, it causes the flexible member to flex, causing the tactor near an end to move and contact a body part. In FIGS. 2A and 2C, the rotating mass 203 is not causing the flexible member 201 to contact the body part; in FIGS. 2B and 2D, the rotating mass 203 is causing the flexible member 201 to contact the body part.

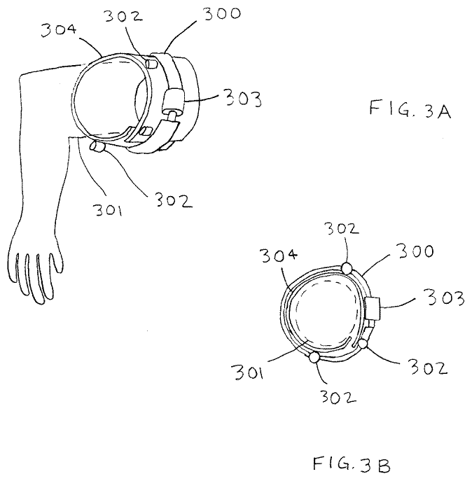

FIG. 3A is a perspective view, and FIG. 3B is an end view, of a haptic strap for covering a portion of a body part, such as a forearm or calf, where the haptic strap includes apparatus for computer-controlled tightening of the strap around the body part. The haptic strap may also include one or a plurality of TAs, including but not limited to ERMs and LRAs.

The haptic strap is typically configured not to stretch much. The haptic strap may comprise nylon, plastic, leather, steel, or other convenient materials. The haptic strap may include one or a plurality of flexible tendons, such as steel wire, Kevlar, Dacron, and/or tungsten cable. The haptic strap may include an actuator, including but not limited to a linear actuator, a solenoid, a motor, and the like. The actuator may be computer controlled, and may tighten the haptic strap programmatically to provide a haptic sensation for the user to perceive. The haptic strap may provide a desired force and/or pressure-versus-time profile to a body part.

A band may be associated with the haptic strap. The band may be soft and/or flexible, to provide a comfortable support for the haptic strap to a body part. The band may include foam and/or gel. The band may be secured using Velcro®, a hook-loop structure, buckle, or other convenient attachment structure.

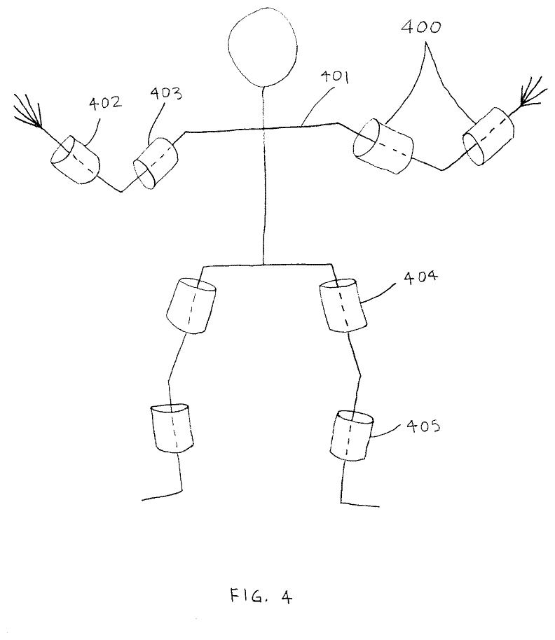

FIG. 4 is a frontal “stick-figure” view of exemplary placement of haptic bands on portions of a human body, including a forearm, biceps, wrist, finger, palm, hand, thigh, hamstring, quad, calf, ankle, foot, toe, waist, head, forehead, earlobe, and/or any other desired body part. Typical placements of a haptic band include around muscles of body extremities.

A haptic band may be configured to contract and expand, where such contracting and expanding may be by computer control. A haptic band may include TAs, vibrotactile stimulators, including but not limited to ERMs and LRAs. Each haptic band and/or TA may receive a separate coordinated activation signal, which may be computer controlled. The activation signal may be selected for each user, and may be selected to address a specific user ailment.

Haptic bands with or without TAs may be positioned all over a body, and each element may receive control signals having differing phased actuations throughout the day to desynchronize neuronal populations.

FIG. 5 is an end view of an ERM and haptic band around a body part, such as a finger. When the eccentric rotating member of the ERM rotates to a top position, it may pull the band tighter, causing the tactor to indent the body part. Foam, or any other convenient return structure, may be used to retract the tactor from the body part when the eccentric rotating member rotates away from the top position, releasing tension in the band.

FIG. 5 provides an apparatus comprising a motor having a cam and/or eccentric mass, a band or equivalent attachment structure, foam, and optionally a tactor, and optionally an accelerometer. The motor may be held in functional relationship to a body part, such as a finger, toe, arm, leg, abdomen, and the like, by the band. The accelerometer may sense tremor of the body part. The foam may provide the function of a return spring for the tactor.

In a useful embodiment, the motor of a TA may be programmed to operate and provide a haptic stimulation in response to a signal from an accelerometer. In this way, when tremor of a body part is detected by the accelerometer, one or more TAs may be activated to the same body part, or to a different body part, to provide a therapeutic stimulation to a user. The therapeutic stimulation may help desynchronize abnormal neuronal activity to reduce or eliminate undesirable body-part tremor.

In a useful embodiment, as the motor rotates, an eccentric mass rotates. When the mass is offset to the top, e.g., away from the body part, the band is pulled tighter to pull the tactor against the body part, such as a finger or toe phalanx or tip, compressing the foam, or another type of return spring, such as a flexible cantilever. When the eccentric mass is proximal to the body part, tension in the strap is reduced, and the foam retracts the tactor to reduce and/or remove pressure between the tactor and body part.

Instead of employing foam, a flexible cantilever extending from near the motor may be used. Such a flexible cantilever may be used to avoid having any structure (such as foam) near a tactor from contacting the body part until the tactor is forced into contact with the body part. Such a configuration will help make contact between the tactor and body part more noticeable for the user.

There may be multiple cams and/or eccentric masses on a single motor shaft, each with its own separate band and tactor, so a single motor may actuate multiple tactors to apply separate tactile sensations to a body part with desired phasing between the tactile sensations.

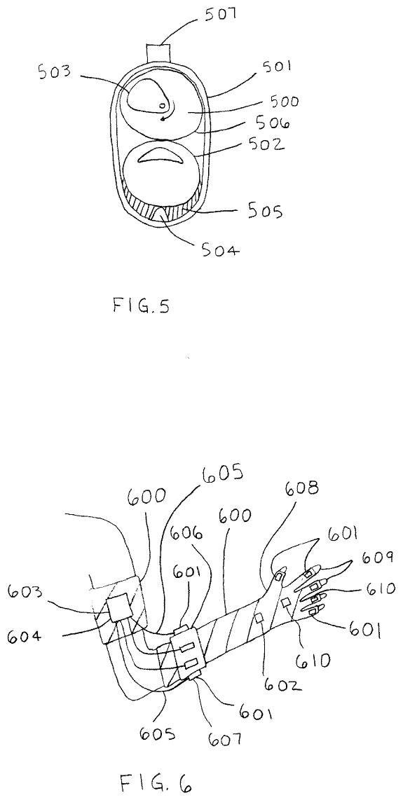

FIG. 6 is a side view of a haptic sleeve. The haptic sleeve may be configured for positioning on an arm, hand, finger, or other body part, and may provide sensing and activation. A useful embodiment includes a plurality of TAs, such as ERMs and/or LRMs, a plurality of tactors, a plurality of accelerometers, a sleeve controller, and a battery. The sleeve controller and battery may be connected to the TAs by wires. The haptic sleeve may optionally include a computer-controlled tightening strap and/or programmable vibro-restriction band. The haptic sleeve may also include electrodes to detect muscle activation signals, and in particular, to detect unwanted or aberrant muscle activation signals. The sleeve controller, or a separate wireless device such as a mobile phone or tablet, may receive one or more sensing signals from the electrodes and/or the accelerometers, process those sensing signals, and provide a haptic signal to one or more sleeve TAs, including but not limited to an ERM or LRM, with or without tactors.

The haptic sleeve may include a hand covering. The hand covering may include open fingertips, and may include accelerometers and/or tactors, and may include combined accelerometers and tactors.

FIG. 7 is a side view of a haptic sock. The haptic sock may be configured for positioning on a leg, calf, foot, toe, or other body part, and may provide sensing and activation. A useful embodiment includes a plurality of TAs, such as ERMs and/or LRMs, a plurality of tactors, a plurality of accelerometers, a sock controller, and a battery. The sock controller and battery may be connected to the TAs by wires. The haptic sock may optionally include a computer-controlled tightening strap and/or programmable vibro-restriction band. The haptic sock may also include electrodes to detect muscle activation signals, and in particular, to detect unwanted or aberrant muscle activation signals. The sock controller, or a separate wireless device such as a mobile phone or tablet, may receive one or more sensing signals from the electrodes and/or the accelerometers, process those sensing signals, and provide a haptic signal to one or more sock TAs, including but not limited to an ERM or LRM, with or without tactors.

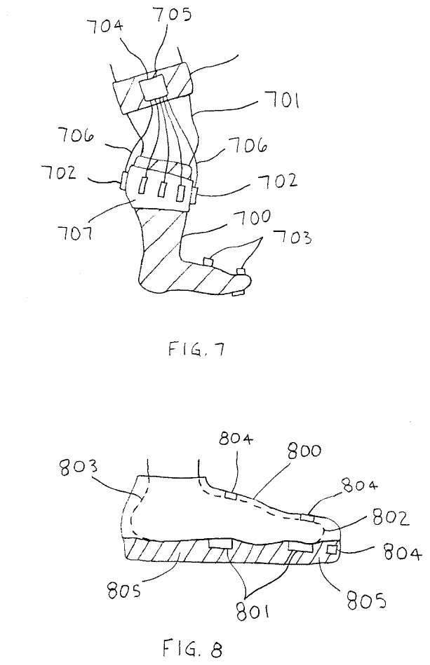

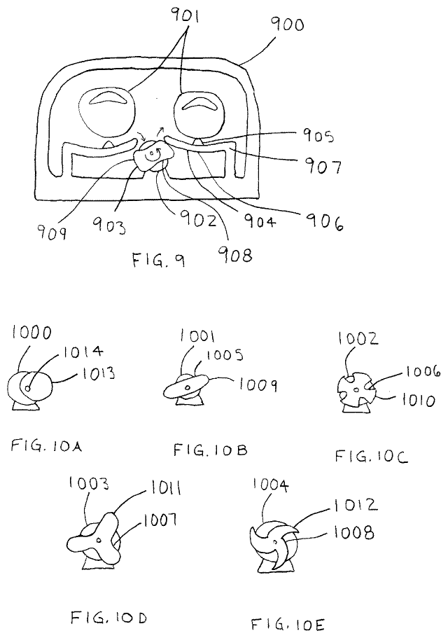

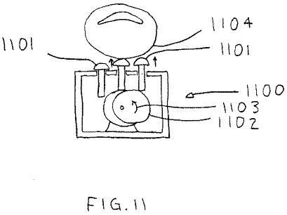

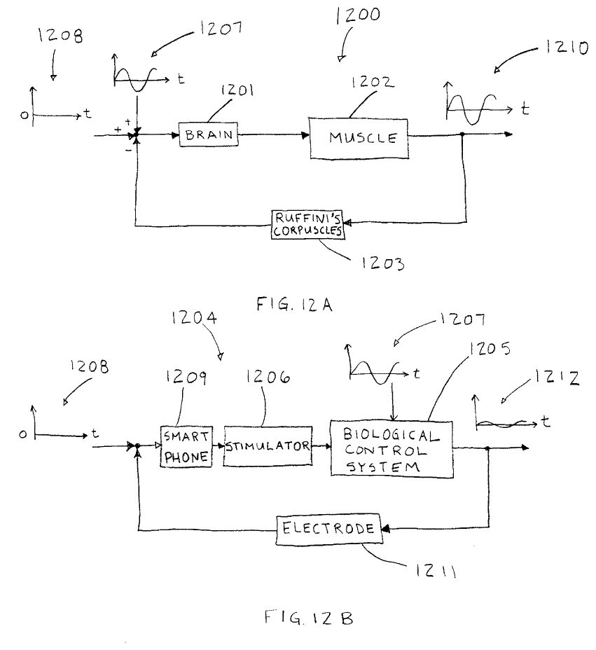

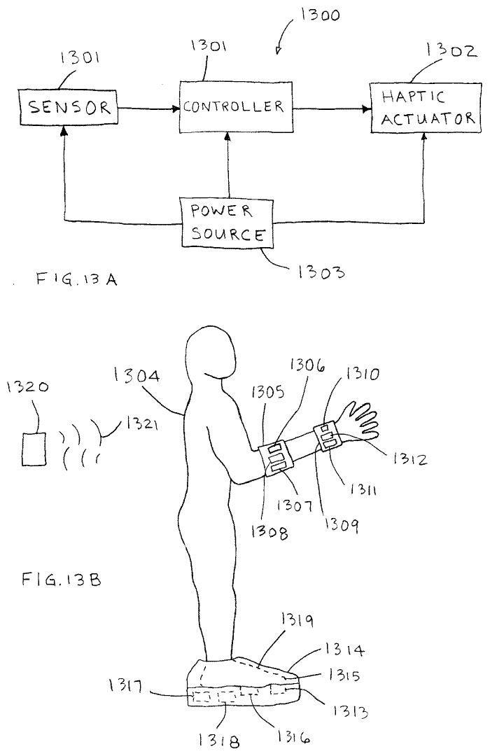

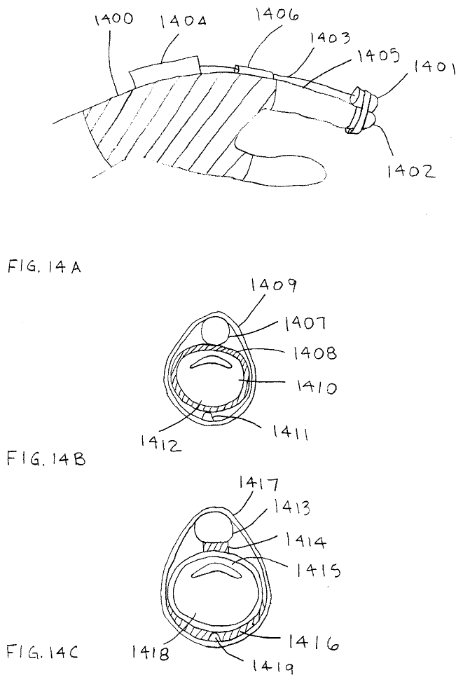

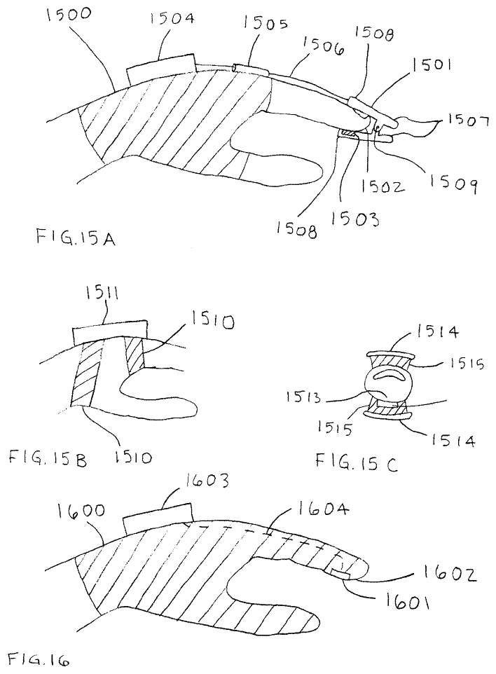

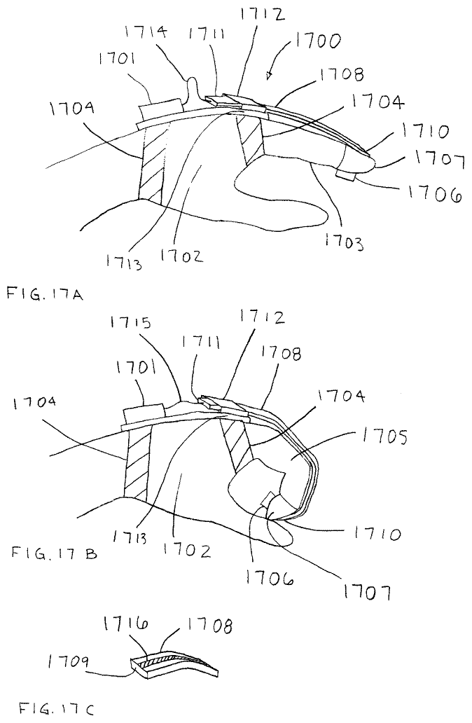

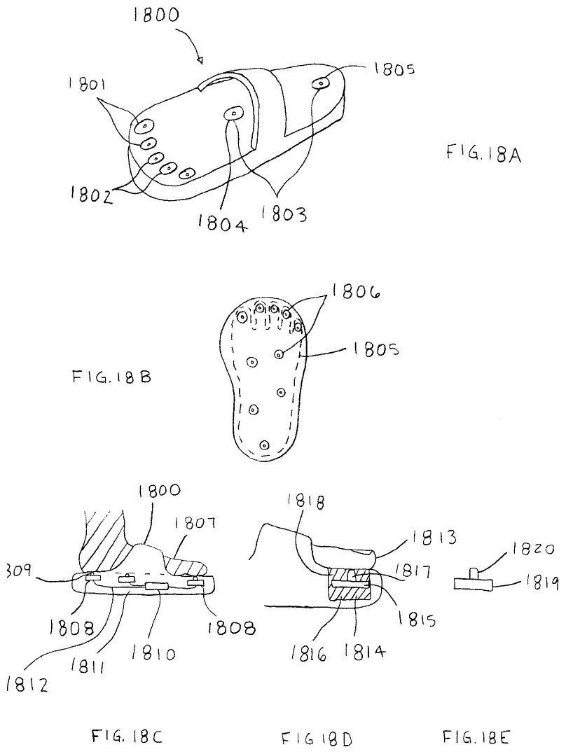

FIG. 8 is a side cross section view of a haptic shoe having TAs, including but not limited to ERMs and LRAs, for applying a haptic sensation to toes, and optionally to other areas of a foot. The shoe may also include one or a plurality of accelerometers. An accelerometer may be positioned anywhere on the body, and for a haptic shoe, an accelerometer may typically be positioned above or to the side of a toe, above the instep, or configured in the sole of a haptic shoe near a toe, including but not limited to beneath a toe, to the side of a toe, or just beyond the distal end of a toe. TAs may be positioned beneath a foot and/or toes, and may be positioned in the sole or in an insert in the haptic shoe. TAs may also be positioned above or to the side of a foot and/or toes, and may include connecting structure, which may include straps, to tactors that are positioned beneath the foot and/or toes.

FIG. 9 is an end cross-section view of two toes inside a haptic shoe, sock, and/or an insole. (Other toes are not shown.) In a useful embodiment, a TA, including but not limited to an ERM or LRM, has a rotating member that causes a flexible member, optionally with a tactor, to flex, causing the tactor to contact a body part, such as a toe 901. The TA may be located below toes, between toes, above toes, or to the side of toes. The TA may be located in the sole portion of a haptic shoe. The TA may be located in the sole portion of a haptic shoe and beneath, to the side, or above, any portion of a foot.

A useful embodiment includes a tactile stimulator positioned in contact with a toe by a flange extending from a flexible hinge.

FIG. 9 provides a rotary motor with optional gearbox to increase torque and reduce rotary velocity. The motor may include a cam having optional gaps between lobes periodically to engage and disengage with the flange, causing the flange periodically to contact a body part, such as a toe, when the motor rotates. The cam may also be attached eccentrically to the motor shaft to provide a vibrational haptic sensation by shaking, in addition to contact-no-contact sensation provided by the flange. The flange may include a tactor to help focus tactile sensation on a specific region of a body part.

FIGS. 10A-10E are end views of rotating actuators, where such actuators may be used to cause a flexible member to flex, including, but not limited to the flexible member of FIG. 9. Each of the rotating actuators of FIGS. 10A-10E provides a different cam shape. The different cam shapes may provide different gaps between lobes, and provide different timing profiles for engagement and disengagement with a flange, such as a flange of FIG. 9, causing the flange periodically to contact a body part, such as a toe, when the motor rotates. The cam of FIG. 10A is attached eccentrically to a motor shaft, and may provide a desired engagement and disengagement with a flange, while simultaneously providing a haptic vibration by shaking.

Any of FIGS. 10A-10E may also include a plurality of axially concentric cams. Such axially concentric cams may be placed on the same motor shaft and angularly offset, so many different tactile stimulators may be engaged by a single motor at desired times and phases, on the same or on different toes or portions of a foot or hand.

The cams and eccentricities provided in FIGS. 10A-10E, as well as the number of cams per motor shaft, may be selected to provide a desired haptic stimulation without departing from the scope or intent of this invention.

FIG. 11 is an end view of a TA, such as an ERM, with lifter-pin tactors. As the rotating member of the ERM rotates, it forces the lifter-pin tactors to move and contact a body part, such as a finger, toe, arm, leg, abdomen, and the like. The tactors may be magnetic so they may be held in a desired position by magnetic attraction. The tactors may be bi-stable magnetic, i.e., a tactor may have at least two positions along its allowed travel where the tactor will be held in place by magnetic attraction until forced to move to a different position.

FIG. 12A is a schematic feedback control block diagram for how a brain may control an arm muscle, where Ruffini's corpuscles provide a feedback sensor. FIG. 12B is a schematic feedback control block diagram for a computer-controlled system to sense a first body part, such as of a biological control system, and control one or a plurality of TAs to stimulate a body part, which may be the first body part, or a second body part, to help retrain and desynchronize abnormal neuron synchrony.

Included in FIGS. 12A and 12B is a feedback block diagram of a Parkinson's disease tremor entering a brain-body control system as noise. In the figures, the control system set point=0 movement; controller=CD (e.g., smart phone); actuator=TA; plant=arm/hand/body; disturbance=Parkinson's disease shaking signal; output=activation signal sent by brain; sensor=EAE; feedback signal=SMR (sensory-motor rhythm).

Parkinson's disease tremor may be caused by an unstable control system for controlling the signal to a body's limb muscle. It is suspected that Ruffini's corpuscles that sense ligaments, tendon stretch, and proprioception, may be atrophying and providing a weak and/or delayed (or a sporadic, or too strong) feedback signal through the nervous system to the brain, so the brain sends the wrong signal to the limb muscle to compensate, resulting in tremor of the limb.

FIG. 13A is a block diagram of a controller, sensor, haptic actuator (such as a TA), and power source. The controller may include multiple controller devices, where the sensor and haptic actuator may each have a separate controller that communicates via wires and/or wirelessly with a main application controller. The power source may include multiple power sources, where the sensor and sensor controller have a power source, the actuator and actuator controller have a different power source, and the main application controller may have another power source.

FIG. 13B is neuro-feedback system for a body. The system may include a forearm strap, where the forearm strap may include a sensor. The sensor may include an electrode, and may sense a neuron signal. The forearm strap may include a power source, such as a battery, and a controller, which may include wireless communication.

The neuro-feedback system may also include a wrist strap, where the wrist strap may include a sensor. The sensor may include an accelerometer for sensing movement of the wrist and/or hand. The wrist strap may include a power source, such as a battery, and a controller, which may include wireless communication.

The neuro-feedback system may include a TA, or more generally, a haptic stimulator. The TA may be located anywhere on the body. In the exemplary embodiment of FIG. 13B, a TA is provided in a haptic foot holder or foot support, such as a shoe, boot, sandal, insole, and the like. In a useful embodiment, the haptic shoe includes a TA for at least one toe, and may include a TA for each toe. There may be a TA for other portions of the foot, such as the foot arch, heel, and/or sole. The haptic shoe may include a power source, such as a battery, and a controller, which may include wireless communication.

A haptic insole or haptic shoe may include low-profile vibrotactile discs positioned throughout the insole. Such vibrotactile discs may include, but are not limited to ERMs and/or LRMs. Electronics, including a processor operating a computer program, optional wireless communication, signal conditioning and amplification, and/or a battery, may be placed in the arch. The electronics, may be placed elsewhere that is convenient, including but not limited to an ankle strap over or under a sock.

The neuro-feedback system may include communication from a device not attached to the body, such as a mobile phone, tablet computer, a laptop computer, or other computer, which may communicate wirelessly or by wires, and may communicate using the internet, WiFi, Bluetooth, and may comprise electromagnetic signals, light signals, acoustic signals, and the like. The user may select a computer program application (or app) on a mobile phone or computer to configure and determine operation of the neuro-feedback system. In a useful embodiment, the user may select a neurological condition with the computer program. The electrode in the forearm strap may send a sensed signal, including a neuron signal sensed from one or more neurons, to the computer program. An accelerometer in the wrist strap may detect and send a motion signal to the computer program. The computer program may use the neuron signal and/or the accelerometer motion signal to determine a desired activation signal to send to one or a plurality of TAs in the haptic shoe optimally to reduce symptoms of the selected neurological condition. In another useful embodiment, no neuron signal or motion signal is sensed, and an activation signal is sent to one or a plurality of TAs in the haptic foot holder using pre-set or random timing, or when requested by the user or a third party, to desynchronize abnormal neuronal synchrony.

FIG. 14A is a side view of an embodiment of a fingerless partial haptic glove with a TA secured to a fingertip. The TA may include any convenient haptic stimulator, including but not limited to an ERM or an LRM, and may include a tactor. The tactor may apply haptic stimulation to a fingertip or other portion of the hand or body. The TA may provide vibrotactile stimulation. The partial haptic glove may cover a portion of the metacarpus, and it may cover a portion of the metacarpophalangeal joints, and it may cover a portion of the wrist joint. The palmar region may be open or covered. If covered, it may be covered by mesh. Electrical wires may extend from an electronics module to a TA on the fingertip. The electronics module may include circuitry, and may be positioned on the back of the hand. The wires may extend over the dorsal side of a finger, and the wires may also pass along the side of a finger. The embodiment may include a guide or channel for guiding the wires from the electronics to a TA on the fingertip.

The electronics module may include a controller, signal conditioning, pulse-width modulation (PWM), amplification, battery or other power source, wireless communication, electrode inputs, and the like. The controller may perform PWM in software, or may use electrical hardware, such as a 555 timer chip, or equivalent.

The user may initiate activation of the TAs in the haptic glove. The user may likewise initiate activation of TAs in a haptic shoe, haptic sleeve, haptic sock, and the like. The user may initiate activation of TAs when they notice abnormal neuronal synchrony, such as tremor, or freezing-of-gait (FOG). Alternately, or in addition, the controller may run a computer program that receives signals from one or a plurality of sensors, such as EAEs and/or accelerometers, that detect tremor, FOG, and the like, and initiates and controls activation of TAs.

FIG. 14B is an end view of a TA without foam. The TA may include a VTA, and may include an ERM or LRA, and may be secured to the dorsal side of a fingertip. A TA-securing structure may secure the TA to a fingertip, and a tactor-securing structure may secure a tactor to the fingertip, typically to the pad of the fingertip. The TA-securing structure may include a band or similar structure passed around a portion of the fingertip from the TA; the tactor-securing structure may include a strap or similar structure passed around the TA and a tactor for transferring TA vibrations to the tactor and/or focusing tactile stimulation on a small region and indenting the skin. The band and/or strap may include elastic. When the TA vibrates, tension in the band transfers vibrations from the TA to the tactor, causing the tactor to vibrate indentations in the surface of the fingertip.

FIG. 14C is an end view of a TA including foam. The foam may include any convenient foam, rubber, gel, or other compliant material. The structure of the TA embodiment of FIG. 14C is similar to that of FIG. 14B, but where the structure of FIG. 14C additionally includes dorsal foam between the TA and the dorsal side of the finger, and also includes tactor foam between the strap and fingertip pad. The strap may support one or more tactors in functional relationship to a fingertip pad. The tactor foam may provide a “return spring” to move a tactor away from the fingertip pad, such as when the strap is not pulling the tactor against the fingertip pad. On the dorsal side of the fingertip, the dorsal foam reduces the user's perception of the TA on the dorsal side, allowing the user better to perceive the indentation of the tactor on the pad side of the fingertip. On the pad side of the fingertip, the tactor foam acts as a suspension and return system, helping to spread out the return force over a larger area of the fingertip, where the tactor foam return force moves the tactor to its non-indenting position.

FIG. 15A is a side view of an embodiment of a haptic glove with a clip on a fingertip, where the clip comprises a TA. The clip may clip to any portion of a body part, including but not limited to a fingertip. When the clip is configured for clipping to a fingertip, the clip is referred to as a fingertip clip. A convenient embodiment of a haptic glove includes a fingerless partial haptic glove. The TA may include any convenient haptic stimulator, including but not limited to a disc or cylinder ERM or LRA. The partial haptic glove may include an electronics module, and the electronics module may be positioned on the dorsal side of the metacarpus. The partial haptic glove may include a wire channel/guide for guiding electrical wires, typically along the surface of a portion of a hand. A fingertip clip may include a TA. The fingertip clip may be spring-loaded to grip onto the fingertip. The tension in the spring may be varied to produce a comfortable grip force. When the two shorter levers extending from the distal end are pressed together, typically by a different hand, a gap is widened between the two longer levers, allowing a finger to be inserted between the two longer levers on the opposite side of the rotary joint. One or more of the levers of a clip may include one or more TAs. The clip typically includes a spring (not shown here) causing the two longer levers to come together and grip the fingertip when force on the two shorter levers is decreased. A spring-loaded clip may hold a TA to a fingertip. A spring-loaded clip may function similarly to a pulse oximeter.

FIG. 15B is a side view of another embodiment of a haptic glove, such as the partial haptic glove of FIG. 15A. In FIG. 15B, the partial haptic glove is replaced by one or more straps, where the straps may be elastic and they may be adjustable. An electronics module may be attached to the elastic straps.

FIG. 15C is an end view of a TA held against the pad of a fingertip by a clip, similar to the embodiment of FIG. 15A, and further including rubber and/or foam padding. The TA may be any convenient haptic stimulator, including but not limited to a disc or cylinder ERM and/or LRA. The padding provides grip strength for the clip, and lowers the grip force needed to keep the clip from unintentionally coming off the fingertip. The TA is shown positioned in the padding against the pad of the fingertip. The padding helps keep vibrations from the TA from being dampened by the harder structure of the clip, thereby more efficiently conducting haptic stimulation from the TA to the pad of the fingertip.

FIG. 16 is a side view of a haptic glove with a TA positioned against the pad of a fingertip. The TA may be any convenient haptic stimulator, including but not limited to a disc or cylinder ERM and/or LRA. In a convenient embodiment, the TA is sewn into the tip of a haptic glove. The TA may be positioned in a pocket in the tip of the haptic glove. The TA optionally may have a tactor for focusing stimulation of a small region of the fingertip pad. If the TA is positioned in a pocket in the tip of the haptic glove, the tactor may protrude through an opening in the pocket to make direct contact with the fingertip pad. An electronics module may be attached to the glove, typically to the dorsal side of the metacarpus or forearm near the wrist. Electrical wires may extend from the electronics module through channels in the haptic glove to the TA. The electronics module may include a controller, signal conditioning, include but not limited to PWM, amplification, power, such as a battery, wireless communication, electrode inputs, and the like.

FIGS. 17A and 17B are side-perspective views of a useful embodiment of a haptic hand attachment 1700 with an electronics module attached to the back of a hand. FIG. 17A is a side view of the hand with fingers in a mostly extended configuration, and FIG. 17B is a side view of the hand with the fingers in a mostly curled configuration. The useful embodiment includes a TA attached by a TA attachment structure that positions the TA in functional relationship to a fingertip of the hand. The TA attachment structure may include elastic. The electronics module may be attached to the back of a hand using straps. The TA may be electrically connected to the electronics module using a flexible circuit board 1708 with an electrically conducting trace 1716, such as provided in the perspective view of FIG. 17C.

The rectangular cross section of the flexible circuit board allows it to flex about the long axis of the cross section, which allows the flexible circuit board to flex to follow the bending of fingers. The flexible circuit board is attached to the fingertip attachment structure at one end, and the other end of the flexible circuit board is able to slide through a guide relative to the back of the hand to accommodate for a change in length when the fingers bend.

The guide, such as a channel, may be attached to a mounting structure on the back of the hand. The guide may guide the sliding of the flexible circuit board. The guide may guide sliding of stiff electrical wires. For example, a flexible circuit board slides toward the guide when a finger extends, and slides away from the guide when the finger flexes. The electronics module may also be attached to the mounting structure. Straps, typically elastic straps, may hold the mounting structure to the back of the hand. The sliding end of the flexible circuit board may be connected to the electronics with flexible electrical wires, brushes, sliding contacts, and the like. Typically, when the finger extends, the flexible electrical wires collapse or may coil up; when the finger flexes and/or curls, the flexible electrical wires extend and take up the slack as the flexible circuit board slides away from the guide.

FIG. 18A is a perspective view of a haptic foot holder or foot support, such as a haptic sandal, comprising a plurality of TAs for toes and/or a foot. Alternately, the haptic foot holder may comprise a shoe, boot, insole, shoe insert, sock, and the like for supporting a foot. In a convenient embodiment, there is at least one TA supported by a haptic sandal. The haptic sandal may also include a TA, or more specifically, a VTA, for the pad of each toe. There may be additional TAs for the arch, ball of the foot, outer portion of the sole, the heel, and the like. A TA may include a tactor for focusing haptic stimulation.

A haptic foot holder may comprise a crew sock with individual toes coverings in the sock, where the sock includes a TA for one or more individual toes, where each TA is built into an individual toe covering in the sock.

FIG. 18B is a top view of the embodiment of FIG. 18A providing an outline of where a foot may be positioned on the foot holder. FIG. 18B also provides exemplary positions for TAs, which may include vibrotactile stimulators, including but not limited to ERMs and LRAs.

FIG. 18C is a side partially-transparent view of the haptic foot holder of FIG. 18A. A foot is inserted into the haptic foot holder. The foot holder includes TAs that may optionally include tactors to concentrate periodic indention of the skin; although, tactors are not required if the TA vibrates at a frequency that is well perceived by one or more of the four skin mechanoreceptors (Meissner corpuscles, Pacinian corpuscles, Merkel's disks, and Ruffini's corpuscles). TAs in the form of discs, including but not limited to ERMs and/or LRAs, may be used in embodiments where it is desired to minimize the depth requirement of the TA, such as an insole. In foot-holder embodiments such as sandals, shoes, and boots, where there is a thicker sole, cylindrical TAs, including but not limited to ERMs and/or LRAs, may be used. In a useful embodiment, long cylindrical ERMs provide a forgiving placement of the toes based on how far the foot is slid into a sandal or shoe.

FIG. 18C provides an electronics module. The electronics module may be positioned anywhere convenient, including but not limited to being positioned in the sole of the foot holder. FIG. 18C also provides electrical connections from the electronics module to one or a plurality of TAs. The electronics module may include electronics, a controller, a battery, an amplifier, a PWM circuit, and the like.

The electronics module may receive command signals, either by wire or wireless communication. The command signals may come from a mobile phone, a tablet computer, a laptop, a website, a computer server, a haptic sleeve, a haptic sock, a haptic glove, an EAE, an accelerometer, and the like.

FIG. 18D is a close-up side partially-transparent view of the area near a toe of FIG. 18A. A useful embodiment includes foam, rubber, or other compliant material surrounding at least a portion of the TA. The foam may be positioned above and/or below the TA. Foam under the TA acts as suspension, so when the toe presses down, the TA can be pushed down into the foam in order to vibrate. Without the foam, the toe may dampen the TA vibration to the degree that it's less perceived by the user. When the TA includes a tactor for concentrating the tactile sensation on a smaller region of the toe or body part, foam surrounding the tactor may help distribute the retraction force, so the tactor is able to retract farther from the surface of the skin. Foam above the TA and surrounding a tactor provides a compliant surface to support a toe, while allowing a tactor to protrude out from the foam to provide focused tactile stimulation.

FIG. 18E is a side view of a TA which may find use in the embodiment of FIG. 18A. The TA may be any convenient haptic stimulator, include a VTA, and may include but is not limited to a disc or cylinder ERM and/or LRA. The TA may include a tactor pin for concentrating indention into a small region of skin. When an ERM or LRA is used, a frequency of vibration may be selected to match the frequency of one or more desired mechanoreceptors. For instance 30-50 Hz is a sensitive frequency range to stimulate Meissner corpuscles, and 250-300 Hz is a sensitive frequency range to stimulate Pacinian corpuscles. A wide variety of activating signals may be sent to a TA, including but not limited to square waves, sine waves, pulses, and the like. When a plurality of TAs are used, each TA may be activated at the same time, at different times, sequentially, randomly, in pre-set patterns, each with the same time duration or different durations, or any combination of the above. The activation pattern may be selected to desynchronize abnormal neuron synchrony to reduce the symptoms of a specific neurological malady.

FIG. 19A is an end view of an ERM in a housing having a tactor for focused stimulation of a body part, such as a finger or fingertip. The housing may comprise a tube for holding the ERM motor. The tactor may protrude from a portion of an extending structure. The extending structure may include a slope for sliding relative to a rotating member 1906. The rotating member, such as a rotating mass on the motor, pushes against the slope of the extending structure, causing a movable flange to push radially outward, and to move an optional tactor concentrator tip into contact with a body part. Such sliding may cause flexure of the associated movable flange. The extending structure is typically attached to the movable flange. The extending structure may extend into the path of the rotating mass, where when the mass rotates, it pushes against the slope 1905 of the extending structure, causing it to move the tactor against a body part, such as a fingertip or toe tip. The movable flange may include a hinge, which may be a flexible hinge (such as a living hinge) portion of the housing around the ERM.

FIG. 19B is a perspective view of the apparatus of FIG. 19A. FIG. 19B provides the outline of an exemplary separation boundary between the extending structure 1904, and associated movable flange and the housing around the ERM, where the flange may include a portion separated (e.g., cut) from the rest of the housing around the ERM. The housing may comprise a tube for holding the ERM motor.

FIG. 19C is an end view of the apparatus of FIG. 19A, where the rotating mass is rotated to a position where it is pushing against the slope of the extending structure, causing the extending structure and associated movable flange to move the tactor against a body part.

FIG. 19D is a perspective view of the apparatus of FIG. 19C, where the rotating mass has rotated to a position where it is pushing against the slope of the extending structure, causing the extending structure and associated movable flange to move the tactor against a body part.

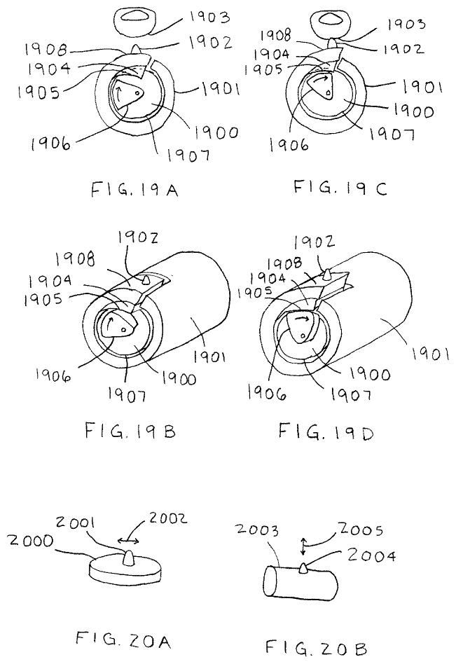

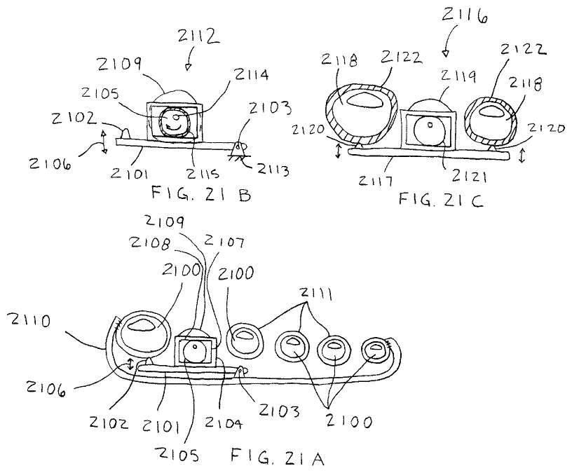

FIG. 20A is a perspective view of a disc TA, such as an LRA, that moves and/or vibrates a tactor from side to side. The TA may include a rotary motor including an eccentric mass for shaking the disc radially in the horizontal plane of FIG. 20A. The disc TA is typically not as tall as it is wide, where the diameter of the disc is a larger dimension that the height. One or more tactors may be placed anywhere on surface of the disc, but when used are typically placed on the flat surface.

FIG. 20B is a perspective view of a cylindrical TA, such as an ERM, that moves and/or vibrates a tactor up and down. The TA may include a rotary motor including an eccentric mass for shaking the cylinder radially outward from an axis through the center of the long dimension. The cylindrical TA is typically longer along its cylindrical axis than is the length of the diameter. One or more tactors may be placed anywhere on the surface of the cylinder, but when used are typically placed on the radial curved surface.

FIG. 21A is an end view of toes of a foot, where an ERM-lever assembly moves a lever to cause a tactor at one end of the lever to stimulate a body part, such as a toe. The lever may also be referred to as a tactor beam. In the ERM-lever assembly, the lever may include a rotary pivot, and the pivot may be at the end of the lever opposite to the tactor. A rectangular guide may be attached to the lever, where a motor 2019 rotates an eccentric mass internal to the rectangular guide, causing the rectangular guide to move up and down as the mass rotates. The short internal dimension of the rectangular guide is typically just slightly larger than the diameter of the mass; whereas, the long internal dimension of the rectangular guide is greater than the diameter of the mass plus the offset of the mass from its center. In this way, when the mass rotates, it only contacts the long internal sides of the rectangular guide. Since the rectangular guide is attached to the lever, as the mass rotates the lever moves a tactor against a body part. The rectangular guide may include Teflon®, or other low-friction or lubricating material, to allow an eccentric member, such as an eccentric mass, to slide freely against the internal surface of the rectangular guide without much friction. The eccentric member may comprise metal, plastic, wood, and the like.

A haptic foot support may include one or more ERM-lever assemblies. The haptic foot support may comprise a strap, where the strap may include elastic. The haptic foot support may attach at attachment locations to a foot covering. A foot covering may include a toe sock which is a sock with individual coverings for each toe.

A haptic foot support may also include a shoe, boot, insole, shoe insert, sock, and the like for supporting a foot.

The motor of the ERM is provided attached to the haptic foot support. The motor may be positioned above or below the lever.

FIG. 21B is an end view of a useful embodiment of an ERM-lever assembly for stimulating a toe and/or other body part. FIG. 21B is a close-up view of the ERM-lever assembly of the apparatus of FIG. 21A. At one end of a lever (a.k.a. tactor beam) is a tactor, and at the other end of the lever is a pivot for attachment of the lever to a haptic foot support. A motor for rotating the eccentric mass may be positioned above or below the lever. The rotating mass may be round. The rotating mass may be mounted off center relative to the output shaft of the motor in order to create an eccentric mass from a round rotating mass.

The rotating mass may include surrounding Teflon, such as a cylindrical Teflon tube, or other low-friction material, to minimize friction when the mass slides against the internal surface of a rectangular guide attached to the lever. The rectangular guide may also comprise Teflon, such as a rectangular Teflon tube, or other low-friction material. In this way, when the eccentric mass rotates, the Teflon surface surrounding the eccentric mass, such as a cylindrical Teflon tube, moves relative to a rectangular Teflon surface, such as a rectangular Teflon tube attached to the lever, to minimize friction. As the eccentric mass rotates, the cylindrical Teflon tube surrounding the eccentric mass causes the lever to move up and down by moving the rectangular Teflon tube up and down, causing the tactor to indent a body part, such as a toe.

FIG. 21C is an end view of another useful embodiment of an ERM-lever assembly for moving a lever structure to stimulate more than one toe or body part simultaneously. Similar to the ERM-lever assembly of FIG. 21B, FIG. 21C includes a motor attached to the haptic foot support. FIG. 21C provides a lever with multiple tactors, each tactor for indenting a different portion of a body part, or multiple body parts, when a mass rotates. A foot covering may include an optional toe sock which is a sock with individual coverings for each toe.

FIG. 22 is a top view of a haptic foot holder or foot support, such as a shoe, and/or a sandal, and/or an insole, and the like, including one or a plurality of TAs. If a haptic foot holder only includes one TA, it is typically positioned under the pad of the second toe, since the second toe has more afferent nerve fibers than the first toe, a.k.a. big toe. TAs may be positioned at a variety of desirable locations in the haptic foot holder, including but not limited to under the pad of each of the five toes, under the arch, under the ball of the foot, under the heal, and under the sole on the side of the small toe.

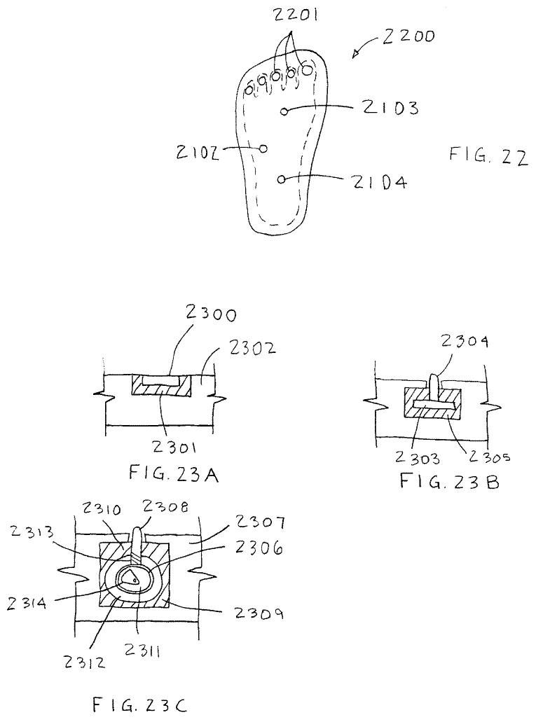

FIG. 23A is a side cross-section view of a TA, such as may be included in a haptic foot holder or foot support, including a shoe/sandal/insole, where the TA may include a disc stimulator or a vibrotactile disc stimulator, and may include but not be limited to an ERM and/or an LRA. The TA may be suspended in foam, typically soft-density foam to medium-density foam. The foam may include polyurethane foam. The foam may be replaced by any suitable elastic or complaint material, such as a gel, that allows the TA to move relative to a body part contacting a portion of the TA. For instance, if a toe were in contact with the top portion of the disc vibrotactile stimulator, the toe could press the disc into the foam, which would allow the TA to vibrate. Without a compliant material, a disc vibrotactile stimulator might be pinched between the toe and a stiff surface, reducing the amplitude of vibration of the disc.

FIG. 23B is another side cross-section view of a TA, such as a disc (or short cylindrical) stimulator, having an optional tactor, and may comprise a motor or other actuator. The TA may be suspended in foam, or other compliant material, such as a gel, and may also include foam over a top portion of the TA. The foam, or other compliant material, on the top and bottom of the disc stimulator acts as a return spring with dampening for the disc, allowing it to move up and down to indent the surface of the skin. Without the foam, or other compliant material, when the toe presses on the tactor, the disc might be pinched against a firm material, reducing the amplitude of vibration of the disc, and thus reducing the perceived haptic sensation.

FIG. 23C is another side cross-section view of a TA, such as may be included in a haptic foot holder or foot support, including a shoe/sandal/insole, where the TA may include a disc stimulator or a vibrotactile disc stimulator, and may include but not be limited to an ERM and/or an LRA. The TA may comprise a long cylindrical ERM, having a tactor, and suspended in foam, or other compliant material, and may also include foam over a top portion of the TA. The foam, or other compliant material, may be any convenient elastic material, including but not limited to a gel or medium density, open-cell, polyurethane (PU) foam, and the like. A motor or other actuator body may be surrounded in a tubular housing having a drilled and tapped hole, where a tactor has a threaded end for screwing into the tapped hole. The tubular housing may be made from any convenient material, including but not limited to Teflon. The tubular housing may be a Teflon tube. As the motor rotates an eccentric mass, the ERM vibrates, and the tactor impacts and indents a body part. The foam, or other compliant material, suspending the tubular housing allows the housing and tactor to vibrate with little resistance or dampening to motion.

Any of the haptic shoe/sandal/insole embodiments presented here that include a TA, and in particular a VTA, may include soft foam, such as polyurethane foam, placed around vibrating tactors. The foam is typically placed below, and optionally to the sides and top, so the vibrations from the VTA aren't dampened by the support structure or pressure from a body part, such as a foot or toe.

For any of the haptic shoe/sandal/insole embodiments presented here, and in particular a haptic shoe/sandal/insole configured for haptic therapy for freezing-of-gait (FOG), where the shoe/sandal/insole includes a TA, and in particular, a VTA, the user may enable vibrotactile stimulators. The VTAs typically have tactors. The user may use a wireless key fab, a mobile phone, a wired switch on the shoe, and the like, to enable haptic therapy.

Any of the haptic shoe/sandal/insole embodiments presented here may include a multi-axis accelerometer with a haptic shoe/sandal/insole to detect the characteristic jerky stomp of FOG, which then may automatically enable the tactors. Such tactors may also be referred to as “toe tappers,” “toe tactors,” and/or “toe ticklers.”

A special service may be provided where the user makes their own foot impression, sends, e.g., by mail or electronic file for 3D printing, their foot impression to the service provider, where the service provider fabricates a shoe/sandal/insole customized to position the toe tappers properly under each toe and portion of the user's foot.

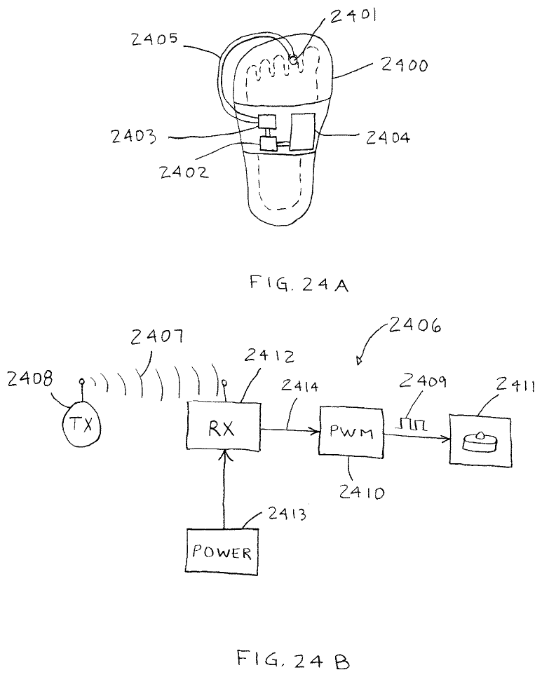

FIG. 24A is a top view of a haptic foot holder or foot support, such as a shoe/sandal/insole including a TA and/or VTA, a controller with programmable processor and wireless communication circuitry, signal-processing circuitry, pulse-width modulation (PWM) circuitry 2403 connected by electrical wires 2405, and a power source such as one or more batteries. In one useful embodiment, 4 AA batteries were used. The haptic foot holder or foot support may include rubber, and may include a shoe/sandal strap which may house or otherwise support the electronics. There may be a plurality of TAs, which may be vibrotactile stimulators, and the stimulators may be suspended in an elastic material, or other compliant material, such as polyurethane (PU) foam. The TAs may be surrounded by PU foam. When worn by a user, this haptic foot holder may be used to reduce the symptoms of freezing of gait (FOG), as well as other neuro pathologies.

Although not explicitly provided in FIG. 24A, the haptic foot holder may include a multi-axis accelerometer and associated computer program to detect the common jerky stomp gait associated with Parkinson's disease walking, a.k.a. freezing of gait (FOG). When FOG is detected by the computer program, one or more vibrotactile stimulators may be activated. A specific pattern of actuation of the vibrotactile stimulators may be used to desynchronize abnormal neuron synchrony to reduce the symptoms of Parkinson's disease, or other neurological malady. The accelerometers may be positioned in, on, or near the haptic foot holder, an ankle strap, an arm band, a wrist band, a waist belt, or any convenient location for sensing abnormal movement of a body part. The sensed signal may be sent by wireless or wired signal to a processor to detect FOG, tremor, or other neurological symptom. One or more electrodes may be used to detect abnormal neuron signals from the brain, a muscle, nerve fiber, and the like.

FIG. 24B is a block diagram of a circuit for receiving a wireless signal from a wireless transmitter, receiving electrical power from a power source, generation of a stimulation signal, which may include generation of a PWM signal by PWM circuitry or a software program, and sending the stimulation signal to a TA. A processor running a computer program may generate the wireless signal sent by the wireless transmitter. A wireless communication device, such as a mobile telephone or computer with wireless transmitter, may comprise the processor and computer program.

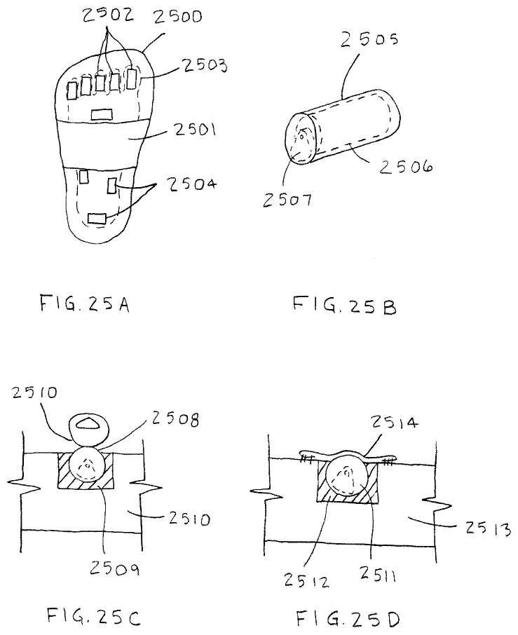

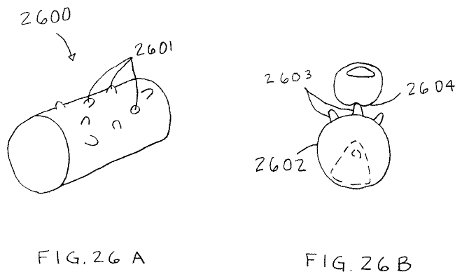

FIG. 25A is a top view of a haptic foot holder or foot support, such as a shoe/sandal/insole, which may include a foot strap, and including one or a plurality of TAs, including but not limited to ERMs and/or LRAs, for providing haptic therapy. In a useful embodiment, a plurality of long cylindrical ERMs is positioned in a haptic foot holder under the toes of a foot as provided in FIG. 25A. ERMs may also be placed at other helpful locations in the haptic foot holder.

Long cylindrical ERMs provide a forgiving placement of the toes, since if the foot slides forward or rearward relative to the haptic foot holder, the sensitive portion of the pad of a toe will still remain in contact with a vibrating portion of the ERM. For the same reasons, long cylindrical ERMs also provide for different foot and toe lengths. An ERM may have one or more tactors to concentration tactile indentation on a desired specific region of the skin to stimulate a targeted mechanoreceptor.

FIG. 25B is a perspective view of a long cylindrical ERM having a rotary motor and mass mounted at other than its centroid to provide an eccentric mass.

FIG. 25C is an end view of an ERM suspended in foam, or other compliant material in the haptic foot holder. The foam, or other compliant material, which may include a gel, provides elastic, damped suspension to allow a vibratory tactile stimulator to vibrate even when pressed into the foam, or other compliant material, by a body part, such as a toe.

FIG. 25D is an end view of an ERM suspended in foam, or other compliant material, in the haptic foot holder, and covered by a flexible covering, typically a thin, optionally elastic covering, to allow the ERM to vibrate without undesirable restriction or dampening when pressed on by a toe or other body part. The flexible covering may help to retain and position the ERM against the foam suspension, or other compliant material. Spandex® may be used as a convenient flexible covering. Other flexible coverings include but are not limited to nylon, polyester, and the like. Convenient suspension materials include foams and other compliant materials, including but not limited to polyurethane, polystyrene (Lux), ethylene-vinyl acetate (EVA) (a.k.a. Poly-Props Ltd Craft foam, a.k.a. Cosplay foam), memory foam, latex foam, polyethylene, polyester, neoprene, and the like. Typical useful densities are soft to medium which allow vibrations without significant dampening; although, some firm foams may be used. The foam may be open cell or closed cell. The suspension material may include a gel.

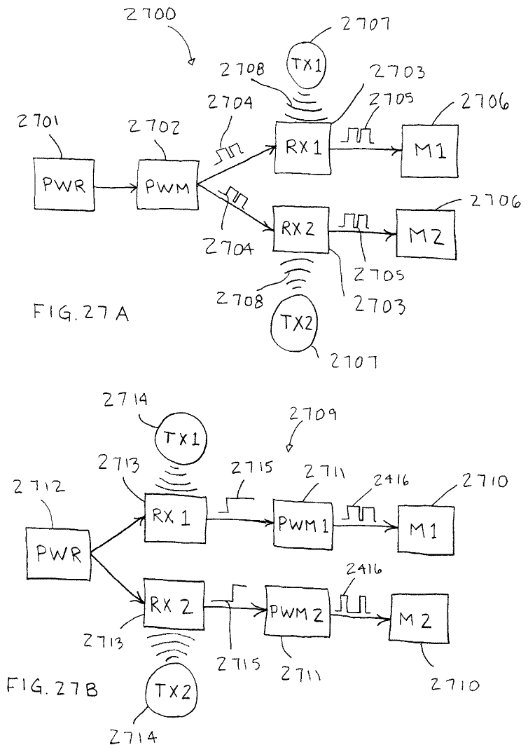

FIG. 26A is a perspective view of an ERM having one or a plurality of tactors for focusing tactile stimulation. An ERM may have one or more tactors to concentration tactile indentation on a desired specific region of the skin to stimulate a targeted mechanoreceptor. When the ERM is a long cylindrical ERM, typically the tactors will extend from the curved surface along the long dimension of the cylinder. When the ERM is a short cylindrical ERM, such as a disc, typically the tactors will extend from the flat circular surface capping an end of the cylinder.

FIG. 26B is an end view of a long cylindrical ERM having at least one tactor for focusing tactile stimulation against a body part, such as a finger or toe.

FIG. 27A is a block diagram of a pulse-width modulation (PWM) configuration for efficiently activating a plurality of vibrotactile motors with a PWM signal. This circuit configuration may reduce the number of PWM circuits necessary to activate multiple motors. In this circuit configuration, a power source, which may include a battery, provides power to a PWM circuit, a plurality of receiver relay circuits, and associated motors. The PWM output of the PWM circuit is input to a plurality of receiver relay circuits, where each receiver relay circuit is for passing the received PWM signal through to an associated motor for providing a vibrotactile stimulation to a body part. Each receiver relay circuit has an associated transmitter circuit that determines whether the relay of the receiver relay circuit is activated to pass the received PWM signal to the motor that is associated with the receiver circuit. In this way, each receiver relay circuit may receive a PWM signal, but the receiver relay circuit must then receive a transmitted signal from a transmitter circuit to activate the relay for the receiver relay circuit in order for the associated motor to receive the PWM signal. The transmitted signal from the transmitter circuit to the receiver relay circuit may be wireless or wired. A wireless signal may include any convenient wireless transmission technology, such as a radio frequency signal, a light signal, such as infrared light signal, an acoustic signal, and the like. The transmitted signal may be modulated.

FIG. 27B is a block diagram of a pulse-width modulation (PWM) configuration for activating a plurality of vibrotactile motors with a plurality of PWM signals. This circuit configuration provides a control technique for enabling one or a plurality of PWM circuits, where each PWM circuit activates an associated motor providing a vibrotactile stimulation to a body part. In this circuit configuration, a power source, which may include a battery, provides power to at least one receiver circuit, its associated PWM circuit, and its associated motor. Each receiver circuit may have an associated transmitter circuit that determines whether and when the receiver circuit enables an associated PWM circuit to activate an associated motor. Alternately, a single receiver circuit may be configured for receiving a plurality of transmitter signals and enabling a PWM circuit associated with the received transmitter signal. Additionally, a single transmitter circuit may be configured for selecting and transmitting a desired transmitter signal for receiving by a desired receiver associated with a desired motor. In this way, the PWM signal to enable an associated motor may be controlled by a transmitted signal. The transmitted signal from the transmitter circuit to the receiver circuit may be wireless or wired. A wireless signal may include any convenient wireless transmission technology, such as a radio frequency signal, a light signal, such as infrared light signal, an acoustic signal, and the like. The wired or wireless transmitted signal may be modulated.

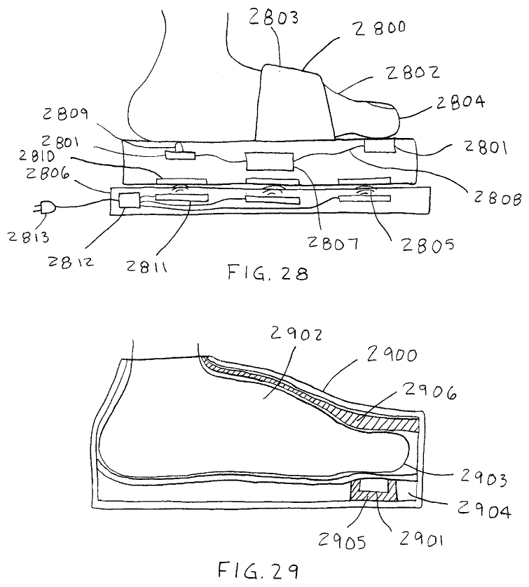

FIG. 28 is a side view of a haptic foot holder or foot support, such as a shoe/sandal/insole, including one or a plurality of TAs, including but not limited to ERMs and/or LRAs, for providing haptic therapy. A foot may be in functional relationship with the haptic foot holder or foot support. The haptic foot holder may include a foot strap. One or a plurality of toes, or other portions of the foot, may be in functional relationship to a TA. The foot holder or foot support may be positioned in wireless communication with a wireless charging foot rest or pad. The foot holder or foot support may include an electronics module, which may include a controller, a battery, amplifier, PWM circuit, charger controller, and the like. The electronics module may be connected by electrical wires to one or a plurality of TAs, which may include tactors. A TA may include an ERM, LRA, other electromechanical actuator, piezo-electric actuator, and the like.

The haptic foot holder or foot support may include one or a plurality of power-receiving coils. The charging foot rest or pad may include one or a plurality of power-transmitting coils, for providing electrical energy to the power-receiving coils. The power-transmitting coils provide electrical energy to the power-receiving coils by transmitting an electromagnetic signal or energy, which may be by wireless electrical induction. The charging foot rest or pad may have a power-transmitting-coil controller. The charging foot rest or pad includes a power source, which may include any convenient power source, and power may come from a wall plug or a battery. The power received by the haptic foot holder from the charging foot rest or pad may charge the battery of the haptic foot holder electronics module.

The charging foot rest or pad may be placed on the ground or floor, built into a foot stool or ottoman, built into any kind of foot rest, floor mat, office floor mat, car floor mat, mattress, mattress foot board, coffee table, recliner chair, and the like.

FIG. 29 is a side section view of a haptic foot holder, haptic-therapy shoe, or haptic foot support, such as a shoe/sandal/insole, including one or a plurality of TAs, including but not limited to ERMs and/or LRAs, for providing haptic therapy. The haptic foot holder or foot support may include a VTA, which may include but is not limited to an ERM and/or LRA. The VTA may be positioned below a foot and/or one or more toes, and may be positioned in the sole or insole of the haptic foot holder or foot support. The haptic foot holder or foot support may include foam or other compliant material as suspension below and/or above the VTA, so when a body part, such as a toe, presses down, the VTA can still vibrate without stalling or having its motion being significantly resisted or damped. The haptic foot holder or foot support may include foam or other compliant material above a toe, to apply pressure on the toe to keep the toe in contact with the VTA while walking. The haptic foot holder or foot support may be referred to as “Solebration,” which is a portmanteau of “sole”+“vibration,” and sounds like “celebration.”

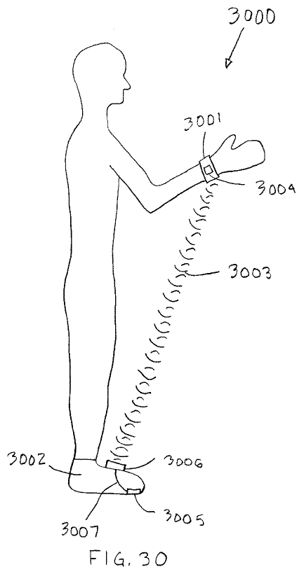

FIG. 30 is a side view of a haptic-therapy system, including a wrist-mounted assembly and a haptic foot-mounted assembly. The wrist-mounted assembly may communicate wirelessly two-ways with the haptic foot-mounted assembly. The wrist-mounted assembly may include a motion sensor, which may include one or a plurality of accelerometers, and may include a processor, and a wireless transmitter and receiver. The wrist-mounted assembly may include an Apple Watch, a Fitbit, Google Pixel Watch, and the like.

A haptic foot-mounted assembly may include haptic-feedback apparatus for applying haptic feedback to a portion of the foot, including but not limited to a toe or a portion of the sole of the foot. The haptic-feedback apparatus may include a TA, including but not limited to one or a plurality of TAS, including but not limited to ERMs, LRAs, and the like, which may include tactors. The haptic foot-mounted assembly may include a processor, wireless or wired receiver, wireless or wired transmitter, power supply, and the like. The processor and power supply in the haptic foot-mounted assembly may connect to each other and to the haptic-feedback apparatus by electrical wires, which may provide power and signal transmission.

A first useful embodiment of the invention includes a neuro-haptic system including a haptic stimulator for stimulating a portion of a body; a neurosensor for sensing a neurological signal; a power source; and a controller including a processor, memory, a power source, and a program for receiving the neurological signal, determining a haptic stimulation signal, and sending the haptic stimulation signal to the haptic stimulator; whereby symptoms of a neurological condition of a user are reduced.

A second useful embodiment of the invention includes a neuro-haptic system including a haptic stimulator for stimulating a portion of a body; a movement sensor for sensing movement of a body part and producing an acceleration signal; a power source; and a controller including a processor, memory, and a program for receiving the acceleration signal, determining a haptic stimulation signal, and sending the haptic stimulation signal to the haptic stimulator; whereby symptoms of a neurological condition of a user are reduced.

A third useful embodiment of the invention includes a neuro-haptic system including a haptic stimulator including a haptic actuator in a shoe for stimulating a portion of a foot; a sensor including at least one of (1) an accelerometer in a band for sensing and producing an acceleration signal, and (2) an electrode for sensing and producing a neurological signal; a controller including a processor, memory, and a program for receiving the sensor signal, determining a haptic stimulation signal, and sending the haptic stimulation signal to the haptic stimulator; at least one power source for providing power to the stimulator, sensor, and said controller; and whereby symptoms of a neurological condition of a user are reduced.

Neuro-haptic systems are provided that include a number of different elements, components, features, circuits, and capabilities. It is not practical given space constraints to include a different figure for each possible combination, and so the elements, components, features, circuits, and capabilities are provided individually and in exemplary embodiments to demonstrate clearly the implementation and exemplary combinations of such elements, components, features, circuits, and capabilities that may be combined. Accordingly, any of the elements, components, features, circuits, and capabilities provided in one figure or embodiment may be combined with any of the elements, components, features, circuits, and capabilities provided in another figure or embodiment, to provide another useful embodiment of this invention, as if such elements, components, features, circuits, and capabilities are explicitly provided as combined in a single figure. For example, although not explicitly shown, any embodiment provided may sense one body part or provide stimulation to a body part, which may be the same or a different body part, where example body parts include but are not limited to a finger, palm, hand, forearm, biceps, triceps, humerus, neck, head, ear, nose, face, forehead, tongue, spine, back, abdomen, waist, toe, sole, foot, calf, hamstring, gluteus, genitals, and may include one or a plurality of haptic stimulators, including but not limited to eccentric rotating-mass actuators (ERMs), linear resonant actuators (LRAs) piezoelectric stimulators, electrocutaneous stimulators, electromechanical stimulators, relays, solenoids, computer-controlled tightening haptic straps around a body part, and may include one or a plurality of sensors, including but not limited to neurosensors, electrodes, brain-activity recordings such as electroencephalograms (EEGs), electrocorticograms (ECoGs), and magnetoencephalograms (MEGs), movement sensors, accelerometers, electrode bands around a body part, and may include one or a plurality of controllers, power sources, signal conditioners, amplifiers, pulse-width modulators, attachment structures, suspension foams, gels, and other compliant materials, computer programs and algorithms for detection and stimulation, and the like, and the systems may be used to help reduce the negative effects of any of a variety of neurological disorders, including but not limited to Parkinson's disease (PD), essential tremor, dystonia, epilepsy, dysfunction following stroke, obsessive-compulsive disorder (OCD), Tourette syndrome, dementia, complex regional pain syndrome, and the like.

It is evident from the above description that a new way of treating a neurological disorder with haptic therapy is presented.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

1. A neuro-haptic system comprising:
a haptic stimulator for stimulating a portion of a body;
a neurosensor for sensing a neurological signal;
a power source; and
a controller including a processor, memory, a power source, and a program for receiving said neurological signal, determining a haptic stimulation signal, and sending said haptic stimulation signal to said haptic stimulator;
whereby symptoms of a neurological condition of a user are reduced.

2. The neuro-haptic system according to claim 1, wherein said haptic stimulator includes an eccentric-mass actuator, said neurosensor includes an electroencephalogram, said controller includes a mobile-communication device, and said neurological condition is Parkinson's disease.

3. The neuro-haptic system according to claim 1, wherein said haptic stimulator includes an eccentric-mass actuator, said neurosensor includes an electrode for sensing a muscle-activation signal, said controller includes a mobile phone, and said neurological condition is Parkinson's disease.

4. The neuro-haptic system according to claim 3 further comprising a plurality of eccentric-mass actuators and accelerometers;
wherein said controller receive a plurality of muscle-activation signals and sends a haptic signals to each of said plurality of eccentric-mass actuators.

5. A neuro-haptic system comprising:
a haptic stimulator for stimulating a portion of a body;
a movement sensor for sensing movement of a body part and producing an acceleration signal;
a power source; and
a controller including a processor, memory, and a program for receiving said acceleration signal, determining a haptic stimulation signal, and sending said haptic stimulation signal to said haptic stimulator;
whereby symptoms of a neurological condition of a user are reduced.

6. The neuro-haptic system according to claim 5, wherein said haptic stimulator includes an eccentric-mass actuator, said movement sensor includes an accelerometer, said controller includes a mobile phone, and said neurological condition is essential tremor.

7. The neuro-haptic system according to claim 6 further comprising a plurality of eccentric-mass actuators and accelerometers;
wherein said controller receive a plurality of accelerometer signals and sends a haptic signals to each of said plurality of eccentric-mass actuators.

8. A neuro-haptic system comprising:
a haptic stimulator including a haptic actuator in a shoe for stimulating a portion of a foot;
a sensor including at least one of (1) an accelerometer in a band for sensing and producing an acceleration signal, and (2) an electrode for sensing and producing a neurological signal;
a controller including a processor, memory, and a program for receiving said sensor signal, determining a haptic stimulation signal, and sending said haptic stimulation signal to said haptic stimulator;
at least one power source for providing power to said stimulator, sensor, and said controller; and
whereby symptoms of a neurological condition of a user are reduced.

9. The neuro-haptic system according to claim 8, wherein said haptic stimulator includes a rotating actuator in a shoe for providing vibrotactile stimulation to a toe;
said sensor includes at least one of (1) said accelerometer in a band for sensing movement of a wrist, and (2) said electrode in a band for sensing electrical activation in a forearm muscle;
said controller includes a mobile-phone controller for wirelessly communicating with a second wireless controller on a body, said second wireless controller for controlling at least one of (A) a wrist sensor, (B) a forearm sensor, and (C) a shoe haptic actuator; and
said neurological condition includes a tremor.
